(19) United States
(12) Patent Application Publication
(10) Pub. No.: US 2015/0178821 A1
(43) Pub. Date: Jun. 25, 2015

(54) INTERACTIVE TRY-ON PLATFORM FOR ELECTRONIC COMMERCE

(71) Applicant: The Social Mall, LLC, Austin, TX (US)

(72) Inventors: Aditya Mishra, San Francisco, CA (US); Usman Shuja, Austin, TX (US)

(73) Assignee: The Social Mall, LLC, Austin, TX (US)

(21) Appl. No.: 14/137,046

(22) Filed: Dec. 20, 2013

(51) Int. Cl. G06Q 30/06

(52) U.S. Cl. CPC G06Q 30/0643; G06Q 30/0631; G06T 2210/16; G06T 2207/30196; G06T 2207/10016

(57) ABSTRACT

Systems and methods for offering an online shopping service are provided. In one embodiment, a method is provided for allowing an online shopper to virtually try on one or more products. The method includes storing a user video profile for the online shopper and creating a product video profile for a plurality of products offered for sale by a plurality of online sellers. The method also enables the online shopper to navigate a plurality of online websites associated with the online sellers and enables the online shopper to select a product from the plurality of products offered for sale. The method also includes the step of combining the user video profile for the online shopper with the product video profile corresponding to the selected product to create a user try-on video.

### BACKGROUND

1. Field

The present disclosure relates generally to electronic commerce (e-commerce) and, in particular, to systems and methods for providing virtual interactive video-based “try-on” services.

2. Description of the Related Art

Over the years, online shopping has become a viable alternative to conventional shopping. Instead of physically visiting several stores to browse merchandise, shoppers can now simply purchase products over the Internet. The United States eCommerce retail market is big ($200 B+) and is getting bigger (9% Compound Annual Growth Rate (CAGR) through 2015). However, there are ways that the online shopping experience can be improved. According to a survey conducted by Javelin Strategy & Research in 2013, about 32% of the total number of consumers do not shop online due to the inability to try on wearable products. Therefore, there is an opportunity to increase an online shopping market through virtual “try-on” technologies.

Some companies and early adopters have built virtual try-on solutions which to some extent allow users to try on products online. However, most lack a consumer centric approach and are limited in their technology. Typically, conventional try-on service solutions fall into three categories: photo-based try-on service, live video try-on service, and server-based try-on service.

Photo-based try-on services have several limitations, such as, for example, requiring consumers to upload images for each of the various websites. Thus, each different seller web site requires an image upload process, resulting in multiple image uploads and multiple accounts across the various web sites and applications. Also, the try-on service does not provide an output that is interactive, but typically only displays straight try-on views. Further limitations include the inability to compare prices and the lack of recommendation processes. These limitations may likely result in a poor user experience.

Limitations of live video try-on services include variable performance dependent on the quality of the camera being used and the quality of the graphics processing unit (GPU) and central processing unit (CPU) of the mobile devices being used. Typically, consumers are asked to hold a universally known item (e.g., a credit card) in front of their face to accurately scale the glasses Therefore, the experience on web and mobile devices could be quite different and prone to failures and delays. The tracking is dependent on the ambient lighting, which might impact the performance. In addition, errors such as shakiness of hands, incorrect angle of a mobile device, etc. may lead to tracking failures, thereby impacting the consumer experience.

The server-based try-on service limitations include: a long learning curve and “unnatural” set up efforts for users to get started, which may also result in a poor experience. Also, digitization costs are typically high for creating 3D models of the glasses. Consumers are limited in choices offered by the websites or applications that deploys this technology.

Therefore, there is a need for a solution that provides online consumers with a platform to address their virtual try-on needs and overcome the limitations of the prior art.

### SUMMARY

In accordance with embodiments of the present disclosure, there are provided herein methods and systems in the area of web and mobile ecommerce in which a consumer is able to use a single cloud based platform to try-on and buy various products (e.g., eyewear, jewelry, makeup, etc.) on any third-party website or applications. Techniques of the present disclosure use natural human movement data (e.g., images and video) to generate a user video profile (video representation) which is stored on the cloud based server and the product (which consumer likes to try) is then applied to the user video profiles and streamed back to the consumer. Additionally, the server will also run smart algorithms to make recommendations to the consumers and generate qualified leads for sellers.

According to one aspect of the present disclosure, a system is provided including a communication network; a user device configured to enable a user to enter input data and to provide output data to the user; a virtual try-on platform configured to communicate with the user device via the communication network, the virtual try-on platform configured to store a plurality of user video profiles of a plurality of users and to store a plurality of product video profiles of a plurality of products for sale; and a plurality of third-party seller platforms configured to communicate with the user device and virtual try-on platform via the communication network, each seller platform including a web server for creating a website for a respective seller intending to sell one or more of the products.

In one aspect, the user device is further configured to enable the user to browse the plurality of products for sale on the websites of the plurality of seller platforms and select a first product to virtually try on.

In another aspect, the virtual try-on platform is configured to combine a user video profile of the user with a product video profile of the first product to create a user try-on video, and wherein the virtual try-on platform is further configured to stream the user try-on video to the user device via the communication network.

In a further aspect, the virtual try-on platform is configured to compare prices of the first product offered by different sellers.

In yet another aspect, the plurality of products include at least one of eyewear, glasses, sunglasses, reading glasses, jewelry, make-up, and accessories.

In one aspect, the virtual try-on platform is further configured to analyze physical characteristics of the user and create a recommended user try-on video by combining the user video profile of the user with a product video profile of a second product, wherein the second product is selected by the virtual try-on platform based on compatibility between physical characteristics of the second product and the physical characteristics of the user.

According to another aspect of the present disclosure, a virtual try-on platform includes a front-end configured to communicate with a user device via a communication network; a back-end server configured to obtain a plurality of user video profiles and a plurality of product video profiles, the user video profiles showing at least the faces of a plurality of users, the product video profiles showing a plurality of products at different angles, wherein the plurality of products are offered for sale from a plurality of online vendors; and at least one database configured to store the user video profiles and the product video profiles; wherein the back-end server is further configured to extract data from one of the user video profiles and one of the product video profiles to create a user try-on video; and wherein the back-end server is configured to stream the user try-on video to the user device via the communication network.

In one aspect, the back-end server is further configured to combine data from the one user video profile and the one product video profile to create the user try-on video.

According to a further aspect of the present disclosure, a method is provided including the steps of storing a user video profile for an online shopper; creating a product video profile for a plurality of products offered for sale by a plurality of online sellers; enabling the online shopper to navigate a plurality of online websites associated with the online sellers; enabling the online shopper to select a product from the plurality of products offered for sale; and combining the user video profile for the online shopper with the product video profile corresponding to the selected product to create a user try-on video.

In another aspect, the method further includes the step of streaming the user try-on video to a user device associated with the online shopper.

In a further aspect, the step of enabling the online shopper to select the product further includes the step of providing a “try on” button on a user interface.

In yet another aspect, the plurality of products are products that can be worn on the body or applied to the body of a consumer.

In another aspect, the method further includes the step of allowing the online shopper to purchase the product.

In a further aspect, the method further includes the step of enabling the online shopper to share the user try-on video on a social network.

In one aspect, the step of storing the user video profile includes the step of recording natural movements of the online shopper and saving the natural movements on a user video profile database.

In another aspect, the step of storing the user video profile includes the step of obtaining a recording of natural movements of the online shopper from a user device associated with the online shopper and saving the natural movements on a user video profile database.

In a further aspect, the method includes the step of analyzing the user video profile with respect to product video profiles of the plurality of products to determine one or more compatible products that have physical features compatible with physical features of the online shopper.

In yet another aspect, the method further includes the step of combining the user video profile with each of the product video profiles of the one or more compatible products to create one or more recommended try-on videos.

In another aspect, the method includes the step of inquiring whether or not the online shopper wishes to virtually try-on the one or more recommended products.

In a further aspect, the method includes, if the online shopper wishes to virtually try-on the one or more recommended products, then streaming the one or more recommended try-on videos to a user device associated with the online shopper.

### BRIEF DESCRIPTION OF THE DRAWINGS

These and other objects, features and advantages of the present disclosure will be apparent from a consideration of the following Detailed Description considered in conjunction with the drawing Figures, in which:

FIG. 1A illustrates an overall system and method for implementing a virtual try-on platform for products in accordance with the present disclosure;

FIG. 1B illustrates components of a server configured for implementing a virtual try-on platform in accordance with the present disclosure;

FIG. 2 illustrates a process flow that includes steps that are involved when a consumer logs onto a seller platform and then uses the virtual try-on platform to virtually try on a selected object in accordance with the present disclosure;

FIG. 3 illustrates another embodiment of a process for consumers to see an interactive streaming output of their try-on experience in accordance with the present disclosure;

FIGS. 4A and 4B illustrate exemplary screen shots of the virtual try-on application employed on a mobile device in accordance with the present disclosure, where FIG. 4A illustrates an initial screen presenting the consumer or user with the option to sign-in, sign-up, or explore the platform and FIG. 4B illustrates at least four options presented to the consumer once the consumer has signed;

FIG. 5 illustrates a method for creating a user video profile in accordance with the present disclosure;

FIG. 6 illustrates an exemplary process for using existing user video profiles, historical try-on streams, object streams, and applying smart algorithms to create consumer recommendations in accordance with the present disclosure; and

FIG. 7 illustrates an exemplary method for generating an interactive video stream in accordance with the present disclosure.

### DETAILED DESCRIPTION

The present disclosure describes systems and methods for providing a virtual interactive try-on platform, which can be delivered as a service. The interactive platform uses previously-stored natural human movement data, such as video that is naturally recorded from various applications such as FaceTime™, Skype™, Tango™, etc. Natural human movement videos are videos in which users being recorded are allowed to move any way that they wish to move, as opposed to “synthetic” videos that are created by requiring users to move in a predetermined manner, such as facing right and then slowly moving the head to face left. The platform described herein provides a consumer with one universal virtual try-on profile, or “user video profile,” which is built from their natural movement data. Using these user video profiles, consumers can try on products from different websites. The platform allows users (e.g., shoppers, customers, etc.) to try on various products (e.g., eyewear, jewelry, makeup, accessories, etc.) from third-party e-commerce platforms.

The present disclosure relates to a business model and supporting components (e.g., systems and processes) that will allow sellers (e.g., online retailers/brands/resellers) to use a virtual try-on platform as a service thereby allowing their customers to virtually try on products that are displayed or advertised on their website or applications by incorporating code that would automatically redirect the consumer to the virtual try-on platform. For the purposes of the disclosure, a product may be any item or object that is wearable or that may be applied to the face or head of a user or consumer. The product may be, but not limited to, eyewear (e.g., prescription glasses, sunglasses, OTC reading glasses), jewelry, earrings, makeup, hats, and other accessories that are offered by a seller or brand online. In some embodiments, other wearable products (e.g., pants, shirts, dresses, shoes, etc.) may be suited for other parts of the user's body.

Embodiments of the present disclosure will be described herein below with reference to the accompanying drawings. In the following description, well-known functions or constructions are not described in detail to avoid obscuring the present disclosure in unnecessary detail. The word “exemplary” is used herein to mean “serving as an example, instance, or illustration.” Any configuration or design described herein as “exemplary” is not necessarily to be construed as preferred or advantageous over other configurations or designs. Herein, the phrase “coupled” is defined to mean directly connected to or indirectly connected with through one or more intermediate components. Such intermediate components may include both hardware and software based components.

It is further noted that, unless indicated otherwise, all functions described herein may be performed in either hardware or software, or some combination thereof. In one embodiment, however, the functions are performed by at least one processor, such as a computer or an electronic data processor, digital signal processor or embedded micro-controller, in accordance with code, such as computer program code, software, and/or integrated circuits that are coded to perform such functions, unless indicated otherwise.

It should be appreciated that the present disclosure can be implemented in numerous ways, including as a process, an apparatus, a system, a device, a method, or a computer readable medium such as a computer readable storage medium or a computer network where program instructions are sent over optical or electronic communication links.

Embodiments of the present disclosure will be described herein below with reference to the accompanying drawings.

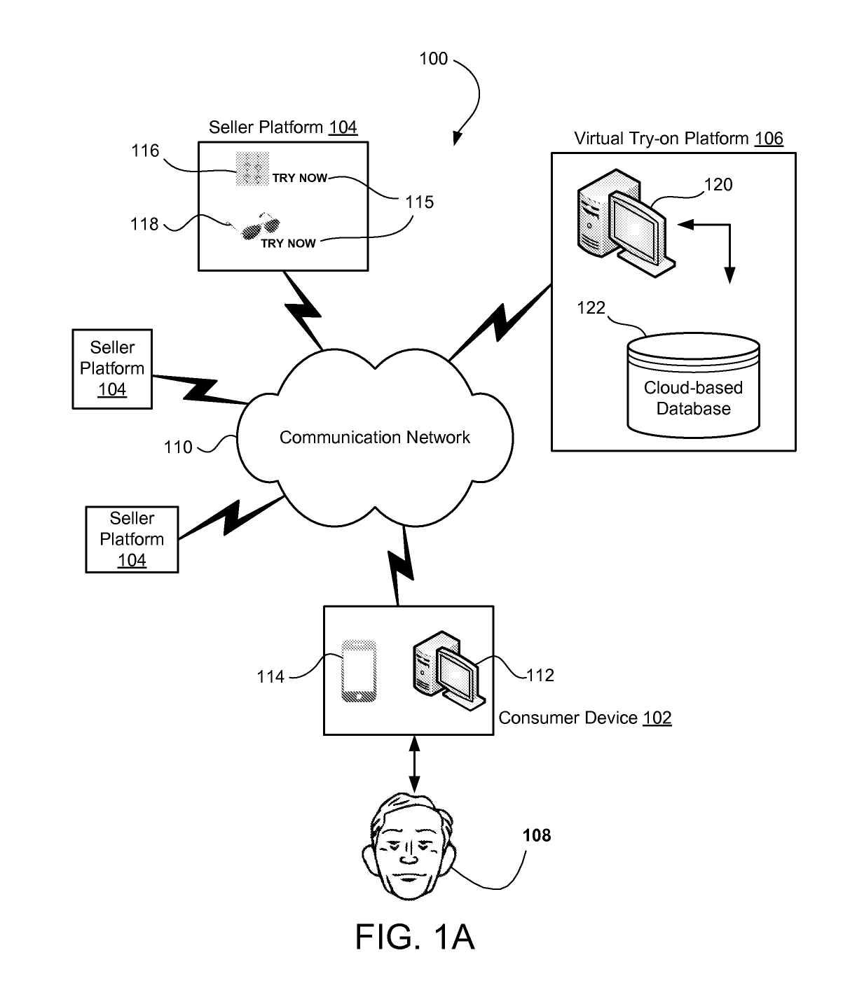

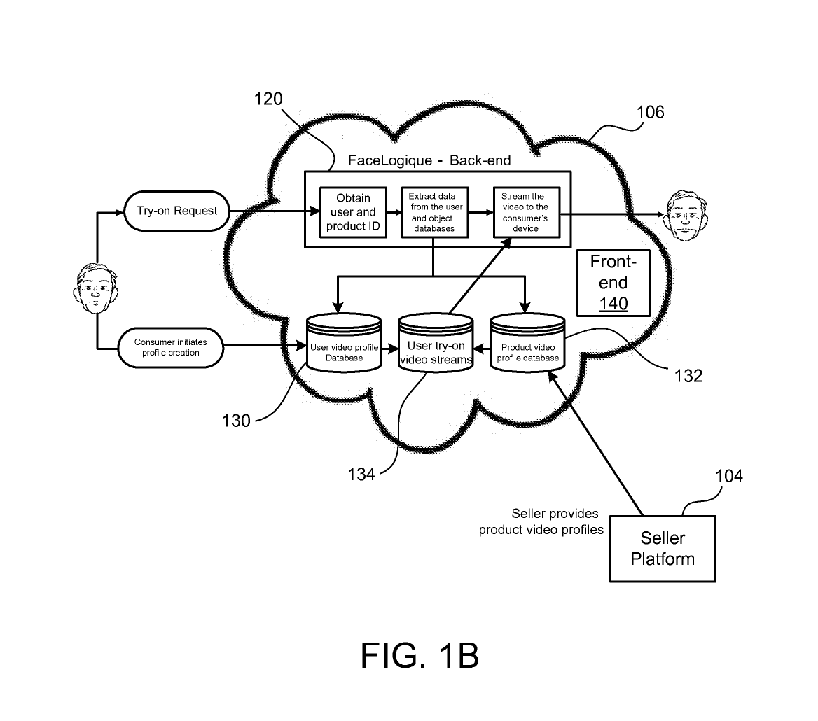

FIG. 1A illustrates an overall system for implementing a virtual try-on service for products in accordance with the present disclosure. The system 100 includes at least one consumer device 102 configured for accessing one or more seller platforms 104 each configured for selling one or more items or products. The system 100 further includes a virtual try-on platform 106 which is coupled to the at least one consumer device 102 and seller platforms 104 via a communication network 110.

The consumer device 102 (e.g., a computer 112, a mobile device 114 (such as a mobile phone, smart phone, or tablet), etc.) is employed by a consumer 108 to browse an ecommerce website of a seller that sells the products that the consumer 108 wants to virtually try. The seller platform 104 includes software code on an ecommerce system and a “link” 115 (e.g., “TRY NOW”) in front of or in proximity to an image or text related to the products (e.g., earrings 116, eyeglasses 118) that the seller wishes to enable for the virtual try-on service using the virtual try-on platform 106. When the user clicks on the “TRY NOW” link 115, the following two events occur: 1) a product handle is passed to the virtual try-on platform 106 (and in some embodiment, a user ID is also passed to the virtual try-on platform), and 2) the consumer 108 is redirected to a front-end of the virtual try-on platform 106 depending on the consumer device 102 employed. For example, if the consumer 108 is employing a computer 112, the consumer 108 is directed to a web site of the virtual try-on platform 106. Alternatively, if the consumer 108 is using a mobile device 114, such as a mobile phone or tablet computing device, the consumer 108 may be directed to a mobile application, also known as a mobile app.

As a back-end server 120 of platform 106 receives the product handle (and in certain embodiments, a user ID), the back-end server 120 matches the product handle to a product video profile that is stored in a database 122. The product video profile is created when a seller signs up to use the services of the virtual try-on platform 106 and provides a detail specification of the product to create a video profile. Further, if the user video profile is already in the database 122 (in certain embodiments, the user video profile is retrieved or extracted based on the user ID), then the user video profile and product video profile are combined and the resulting interactive try-on video is streamed back to the user 108 on their consumer device 102. The interactive video herein means that the user will be able to use the touch functionality or any other pointing device functionality to interact with the streamed video to view various try-on angles. The consumer 108 can then use the try-on video to make the decision to buy or not buy the product. If the user 108 chooses to buy, then clicking a “buy” link displayed on their consumer device 102 will navigate back to the seller platform 104 to complete the transaction. The virtual try-on platform 106 will record the transaction via a cookie or other software code and charge the agreed upon sales commission from the seller. In this manner, the virtual try-on platform 106 provides a single source for a user video profile across multiple vendors using multiple seller platforms 104.

It is to be appreciated that the seller platform 104 and virtual try-on platform 106 may be implemented on a server or via a web site hosted on a server. The server may be implemented on any of the various known computer platforms having hardware such as one or more central processing units (CPU), memory such as random access memory (RAM) and/or read only memory (ROM) and input/output (I/O) user interface(s) such as a keyboard, cursor control device (e.g., a mouse or joystick) and display device. The computer platform may also include an operating system and micro instruction code. The various processes and functions described herein may either be part of the micro instruction code or part of a software application program (or a combination thereof) which is executed via the operating system. In one embodiment, the software application program is tangibly embodied on a program storage device, which may be uploaded to and executed by any suitable machine such as a server. In addition, various other peripheral devices may be connected to the computer platform by various interfaces and bus structures, such a parallel port, serial port or universal serial bus (USB). Other peripheral devices may include additional storage devices and a printer.

The at least one consumer device 102, seller platform 104, and virtual try-on platform 106 may be connected or coupled to each other via a communications network 110 (e.g., the Internet) by any known means, for example, a hardwired or wireless connection, such as dial-up, hardwired, cable, DSL, satellite, cellular, PCS, wireless transmission (e.g., 802.11a/b/g), etc. It is to be appreciated that the network 110 may be a local area network (LAN), wide area network (WAN), the Internet or any known network that couples a plurality of computers to enable various modes of communication via network messages. Furthermore, the platforms 104, 106 may communicate using the various known protocols such as Transmission Control Protocol/Internet Protocol (TCP/IP), File Transfer Protocol (FTP), Hypertext Transfer Protocol (HTTP), etc., and secure protocols such as Internet Protocol Security Protocol (IPSec), Point-to-Point Tunneling Protocol (PPTP), Secure Sockets Layer (SSL) Protocol, etc.

FIG. 1B illustrates many of the components of the virtual try-on cloud-based platform 106. The back-end server 120 interacts with a plurality of databases including a user video profile database 130 and an product video profile database 132. The back-end server 120 stores, ahead of time, user and product video profiles and processes them on request for the best try-on experience. The back-end server 120 also generates personalized recommendations based at least on the compatibility between specific user data and product data. The back-end server 120 is further configured to generate and stream a video by combining the user and product video profile handles when a request is initiated by a consumer. The video generation can be done ahead of time knowing popular objects and the user, or if the seller uploads the database of objects ahead of time so they can be just referenced. Additionally, the back end server 120 runs search algorithms to identify various objects (i.e., products) and price options for consumers to make an informed decision and runs auction algorithms to rank the sellers and brands who sell the same object model.

A front-end 140 of the virtual try-on platform 106, which may be a web site or mobile application, is used by consumers to manage their virtual try-on activities. Such virtual try-on activities may include creating a profile, watching stored try-on videos, and conducting online transactions. Consumers may create a user video profile by either recording a synthetic video or connecting to various apps or data sources used for video calls and images. The front-end 140 may be used to upload images of a particular style and explore similar styles that are being sold by other designers, retailers; this enables a user to have control over the choices available and price sensitivities. In certain embodiments, the front-end 140 may be employed to take an image of an object, convert the image into a 3D model using methods described herein, and virtually try the object on using the existing user video profile.

In a further embodiment, the front-end 140 may be used to recommend an item (e.g., glasses). There may be many objects that have free specifications on the web that can be used to automatically generate these recommendations without help from any seller. This will result in a lead generation business.

In a further embodiment, the front-end 140 may be used to display prices offered by various sellers for the same object/item and multiple promotions that the various sellers are running. This will allow consumers to pick the seller that is best suited to their individual needs. The decision about the seller who will be displayed at the top will be done using suitable auction algorithms or user-selected criteria.

FIG. 2 illustrates a process flow describing steps that are involved when a consumer logs on to a seller platform and then uses the virtual try-on platform to virtually try-on a selected object. Initially, in step 202, a consumer logs onto a seller website. The consumer may browse the web site for products or items that the consumer may be interested in purchasing, step 204. Upon finding an item of interest, the consumer will be presented with the option to virtually try-on the item, step 206. If the consumer decides not to virtually try-on the item, the consumer may continue to browse the web site for other products (step 208) or exit the website (step 210).

If the consumer decides to virtually try-on the item in step 206, the consumer will click the “TRY NOW” button, or other suitable link presented adjacent to the item, step 212. In step 214, the consumer is forwarded to the virtual try-on platform 106, via either a website or mobile application. In step 216, the object/ID specification of the item is transmitted to the virtual try-on platform. Beforehand, the seller, while signing up, provides the object specifications which the virtual try-on platform uses to create a video or allows the virtual try-on platform to use a virtual “mannequin” to put the item on to create a video and store in the virtual try-on database. The virtual “mannequin” is designed for the purpose of creating a video of an object (e.g., eyewear) on “mannequin” heads having various sizes and shapes. This will allow the virtual try-on platform to have standardized video of the objects (e.g., eyewear) which the back-end server 120 will use to compare against the user head size/shape and recommend how well the object (e.g., glasses) would fit the buyer.

After the consumer is forwarded to the virtual try-on platform, the platform will determine if a user video profile already exists, step 218. In one embodiment, the platform will retrieve the user video profile based on the user ID sent from the retailer's website. In other embodiments, the platform may determine the user ID by reading a cookie or other identification from the user's consumer device 102. If a user video profile does not exist, the consumer will be prompted to create a user video profile in step 220. In step 220, the consumer may create a user video profile or make changes to an existing one. In creating or modifying the user video profile, the consumer has two options: 1) allowing the virtual try-on platform to access any of the video-based call services such as FaceTime™, Skype™, Tango™, etc., to record user video in real-time, and 2) create a synthetic video profile based on the instructions provided by the virtual try-on platform.

Once the user video profile has been created (step 220) or has been retrieved (step 218) and the user has been signed in, a video output including a consumer product video and the user video is streamed to the consumer via the consumer device, step 222. At step 224, the consumer is prompted with the option to buy the product. If the consumer decides to buy the product, i.e., by clicking a “BUY” button, the consumer is forwarded back to the seller's web site to complete the transition, step 226; otherwise, the consumer is forwarded back to the seller's web site to continue browsing, step 228.

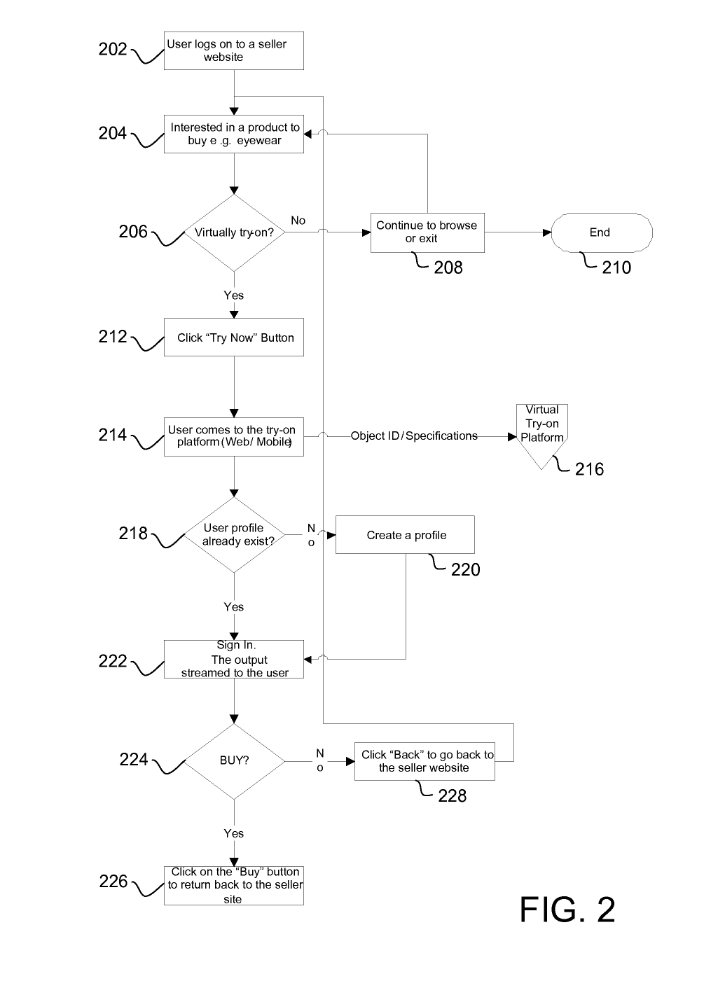

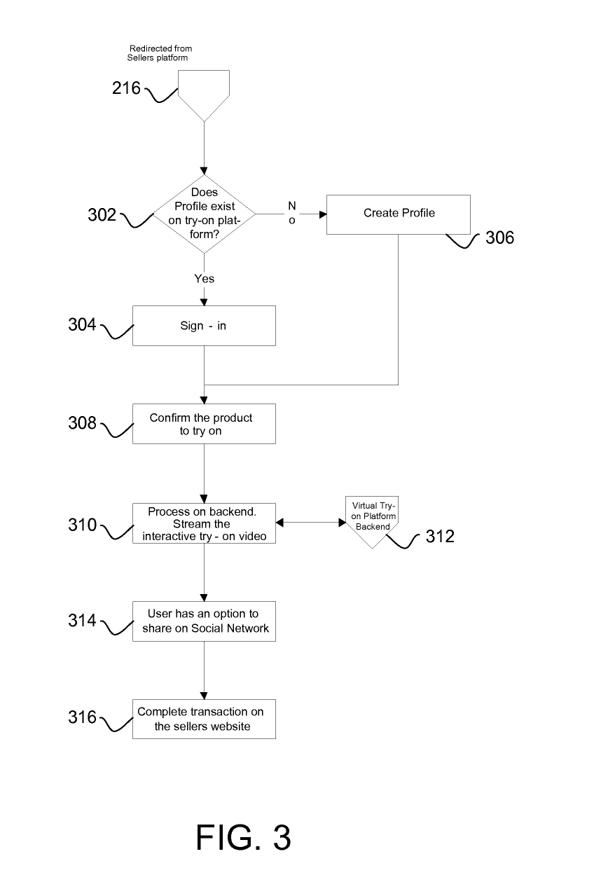

FIG. 3 illustrates an embodiment of a process for consumers to see an interactive streaming output of their try-on experience. In this embodiment, the consumer will have an option to use social networks to take an opinion from friends and family, create polls, etc. In addition, if a user video profile does not exist then they will have an option to create a profile.

In step 216, a consumer is forwarded to the virtual try-on platform as described above with respect to FIG. 2. In step 302, it is determined if the consumer has an existing profile. If the consumer has an existing profile, the user may sign in (step 304); which in certain embodiments, the sign-in information will be employed to retrieve or extract the user's video profile. Otherwise, the consumer will create a user video profile, step 306. In step 308, the consumer confirms that the item or product to be streamed is the product selected by the consumer. The virtual try-on platform then processes the images of the product with the user video profile and streams an interactive try-on video to the consumer (step 310). Block 312 corresponds to the operation of the back-end server 120 shown in FIG. 1B. The back-end server generates a stream by combining the user video profile and the images of the object that the user wants to try-on. The stream is interactive, which allows the consumer to view various angles and assess the “look and feel” of the tried-on object. The consumers will be able to interact with input devices of the consumer device 102 (e.g., using a mouse, keypad, touchscreen, etc.).

While the consumer is interacting with the video stream, the consumer is presented with an option to share the video stream on at least one social network, step 314. This may include, but is not limited to, posting the try-on videos on social media sites to obtain feedback, sharing the videos on various video calls website, messages, emails, other chat programs such as whatsapp. The virtual try-on application will store the videos related to the user video profile and provide the consumer a dashboard of all the comments made from various social networks. The consumer may then return to the seller's website to complete the transaction, step 316.

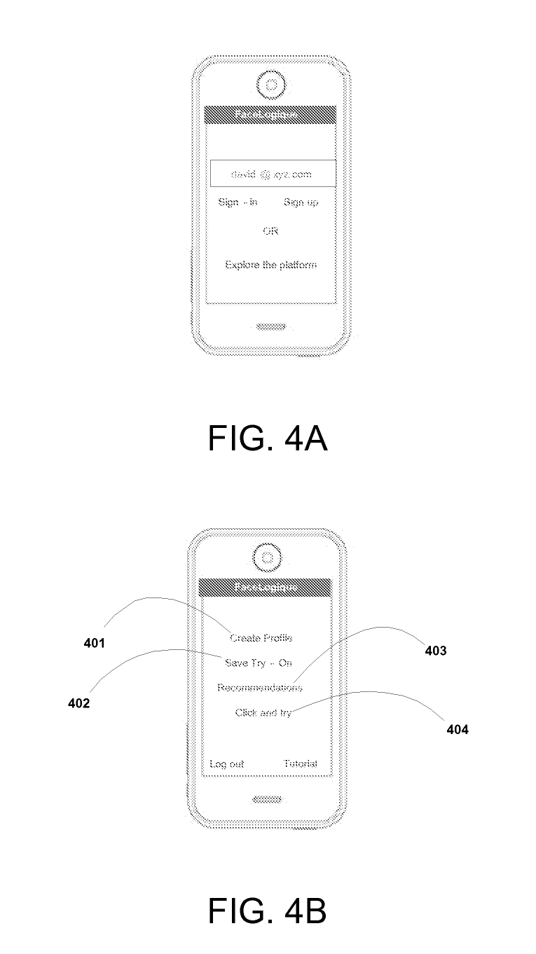

FIGS. 4A and 4B illustrate exemplary screen shots of the virtual try-on application employed on a mobile device. For example, the screen shots may include the front-end of the virtual try-on platform 106. FIG. 4A illustrates an initial screen presenting the consumer or user with the option to sign-in, sign-up, or explore the platform. FIG. 4B illustrates at least four options presented to the consumer once the consumer has signed in. For example, some options may include: 1) Create a user video profile 401, 2) Save a try-on video 402, 3) View recommendations 403, and 4) Click and try 404. The “click and try” option allows a user to capture a picture of a product that the user sees in a store or being worn by another person, and allows the user to upload this picture to the virtual interactive platform to virtually try on the product. The click and try feature is described in more detail below with respect to FIG. 7, and each of the other options are also described below.

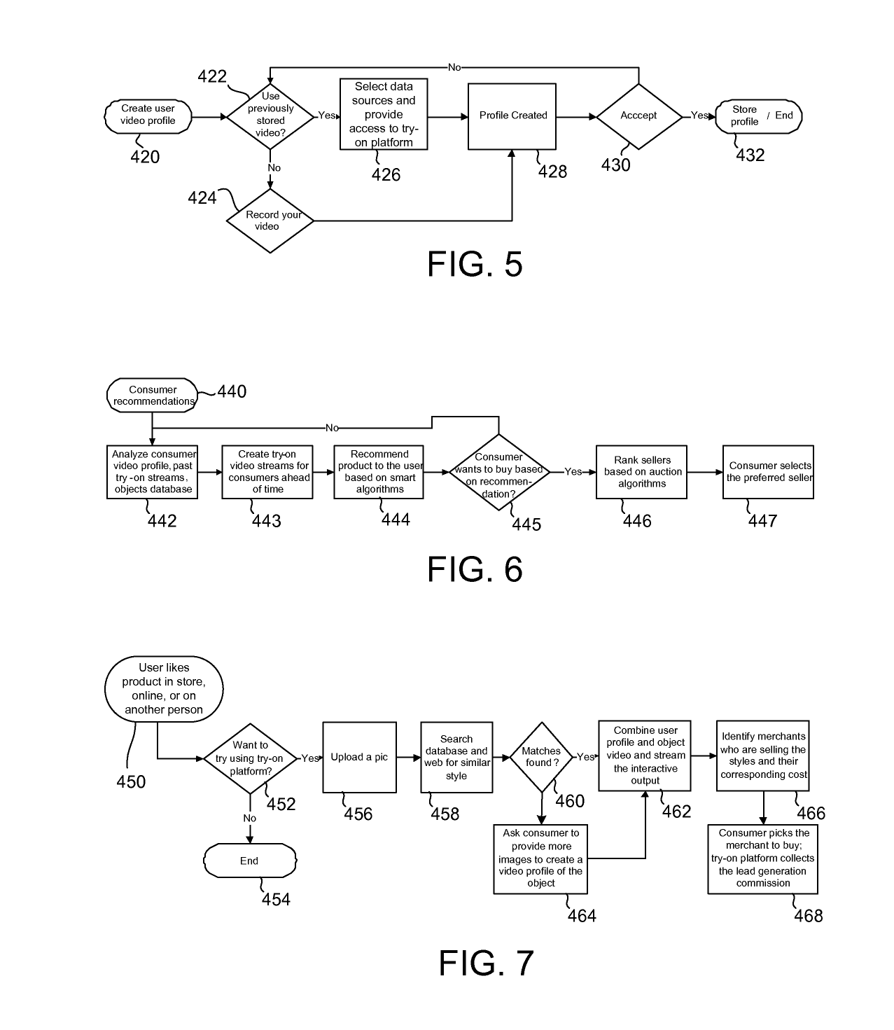

Referring to FIG. 5, a method for creating a user video profile for the consumer is illustrated. Upon selecting the option to create a user video profile (e.g., using the “Create Profile” option 401), a create profile application or module is executed, step 420. The consumer is presented with the option to use previously stored video to create their profile, step 422. If the consumer declines, the consumer will be prompted to record a video in step 424. Otherwise, in step 426, the consumer will select various data sources of previously stored video and provide access to the virtual try-on platform of the selected sources. For example, the sources may include various popular video calling apps, such as FaceTime™, Skype™, Tango™, etc. In addition, the user video profile could also be generated by various photo apps such as iPhoto, Flickr, etc. In step 428, the virtual try-on platform creates the user video profile based on the selected data sources. In step 430, the consumer is presented with the option of accepting the created profile. If the consumer does not accept the profile, the method will revert to step 422 to attempt to create the profile again; otherwise, if the consumer accepts, the user video profile is stored for future use, step 432.

The Save Try-on option 402 of FIG. 4B allows a consumer to save and store, on the virtual try-on platform, previously tried-on items, i.e., videos that were created illustrating the user wearing an item.

The option 403 of FIG. 4B refers to the recommendations that the virtual try-on platform will have for the consumers. Based on various factors such as user video profile, historical try-on experience, and consumer face type, the virtual try-on platform will identify the objects that the consumer might buy. Then, the virtual try-on platform will combine the user and product video profiles to create an interactive video stream and push it as recommendations to the consumers to evaluate. Once the consumer shows interest in buying the object, the virtual try-on servers will identify and rank the sellers where the object is available and present the options to the user thereby giving them the opportunity to buy the object at the price they prefer. Optionally, the virtual try-on platform might also conduct the auction on the servers to rank the sellers and highlight the preferred one.

Referring to FIG. 6, an exemplary process for using existing user video profiles, historical try-on streams, object stream and applying smart algorithms to create recommendations is provided. Initially, in step 440, a consumer activates the Recommendations option 403 as mentioned above. The virtual try-on platform analyzes the user video profile, past try-on streams, and object database to determine object(s) that the consumer might like, step 442. In step 443, the virtual try-on platform creates try-on video streams for the consumer based on the determined products. These videos are created ahead of time so that they can be immediately available to the consumer. Then, step 444, the virtual try-on platform makes a recommendation by showing a product and waits for the user to try it if desired. Thus, the try-on experience may use any existing video profiles to create multiple streams for the users. In step 445, the consumer determines if they would like to purchase any of the recommendations. If so, the virtual try-on platform ranks potential sellers of the item based on auction algorithms, step 446; otherwise, if the user does not wish to purchase, the flow process reverts back to block 442. In step 447, the consumer selects a preferred seller.

Referring to FIG. 7, a method is provided for enabling the functionality of the Click and Try option 404 of FIG. 4B, which allows consumers to click and upload a photo of an object, which the consumer sees in a store or sees someone wearing and which the consumer would like to try-on. Initially, in step 450, a consumer identifies or observes an item the consumer would to purchase and the consumer then decides if they would like to virtually try-on the item (step 452). If not, the process ends (step 454). If the consumer desires to virtually try-on the item, the consumer uploads an image of the item (step 456). In step 458, the virtual try-on platform searches a database of images and various sites on the Internet for items of similar characteristics, e.g., shape, color, style, etc. Then, it is determined if a match is found (step 460). If a match is found, the platform determines if a product video profile already exists for the matched items and, if so, retrieves the product video profile. If no match is found, the virtual try-on platform will prompt the consumer to provide one or more additional images so the virtual try-on platform can create a product video profile of the item, step 464. If the virtual try-on platform finds a match, the virtual try-on platform combines the user video profile and the product video profile and subsequently streams an interactive video output to the consumer, step 462. In step 466, the virtual try-on platform identifies merchants who are selling the items or similarly identified items and presents the items with corresponding costs to the consumer. In step 468, the consumer selects a merchant to complete the transaction, and in certain embodiments, the virtual try-on platform collects a fee, e.g., a lead generation commission, for the selected merchant. In this manner, the virtual try-on platform will use a photo or image to conduct a smart web search and look for the similar models (shape, color, style), find the matching product video profile in the database and apply it to a user video profile to create a video stream. This functionality allows consumers to shop for expensive styles which are available at much cheaper prices on different ecommerce platforms.

In conclusion, the present disclosure provides a scalable and easy to use platform to both consumers and sellers to use for their virtual try-on needs. This will allow the consumers who do not normally shop online to consider it and further improve the sales for the seller.

It is to be further understood that because some of the constituent system components and method steps depicted in the accompanying figures may be implemented in software, or firmware, the actual connections between the system components (or the process steps) may differ depending upon the manner in which the present disclosure is programmed. Given the teachings of the present disclosure provided herein, one of ordinary skill in the related art will be able to contemplate these and similar implementations or configurations of the present disclosure.

It is to be appreciated that the various features shown and described are interchangeable, that is a feature shown in one embodiment may be incorporated into another embodiment.

While non-limiting embodiments are disclosed herein, many variations are possible which remain within the concept and scope of the present disclosure. Such variations would become clear to one of ordinary skill in the art after inspection of the specification, drawings and claims herein. The present disclosure therefore is not to be restricted except within the spirit and scope of the appended claims.

Furthermore, although the foregoing text sets forth a detailed description of numerous embodiments, it should be understood that the legal scope of the present disclosure is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

What is claimed is:

1. A system comprising:
a communication network;
a user device configured to enable a user to enter input data and to provide output data to the user;
a virtual try-on platform configured to communicate with the user device via the communication network, the virtual try-on platform configured to store a plurality of user video profiles of a plurality of users and to store a plurality of product video profiles of a plurality of products for sale; and
a plurality of third-party seller platforms configured to communicate with the user device and virtual try-on platform via the communication network, each seller platform including a web server for creating a website for a respective seller intending to sell one or more of the products.

2. The system of claim 1, wherein the user device is further configured to enable the user to browse the plurality of products for sale on the websites of the plurality of seller platforms and select a first product to virtually try on.

3. The system of claim 2, wherein the virtual try-on platform is configured to combine a user video profile of the user with a product video profile of the first product to create a user try-on video, and wherein the virtual try-on platform is further configured to stream the user try-on video to the user device via the communication network.

4. The system of claim 2, wherein the virtual try-on platform is configured to compare prices of the first product offered by different sellers.

5. The system of claim 1, wherein the plurality of products include at least one of eyewear, glasses, sunglasses, reading glasses, jewelry, make-up, and accessories.

6. The system of claim 1, wherein the virtual try-on platform is further configured to analyze physical characteristics of the user and create a recommended user try-on video by combining the user video profile of the user with a product video profile of a second product, wherein the second product is selected by the virtual try-on platform based on compatibility between physical characteristics of the second product and the physical characteristics of the user.

7. A virtual try-on platform comprising:
a front-end configured to communicate with a user device via a communication network;
a back-end server configured to obtain a plurality of user video profiles and a plurality of product video profiles, the user video profiles showing at least the faces of a plurality of users, the product video profiles showing a plurality of products at different angles, wherein the plurality of products are offered for sale from a plurality of online vendors; and
at least one database configured to store the user video profiles and the product video profiles;
wherein the back-end server is further configured to extract data from one of the user video profiles and one of the product video profiles to create a user try-on video; and
wherein the back-end server is configured to stream the user try-on video to the user device via the communication network.

8. The virtual try-on platform of claim 7, wherein the back-end server is further configured to combine data from the one user video profile and the one product video profile to create the user try-on video.

9. A method comprising the steps of:
storing a user video profile for an online shopper;
creating a product video profile for a plurality of products offered for sale by a plurality of online sellers;
enabling the online shopper to navigate a plurality of online websites associated with the online sellers;
enabling the online shopper to select a product from the plurality of products offered for sale; and
combining the user video profile for the online shopper with the product video profile corresponding to the selected product to create a user try-on video.

10. The method of claim 9, further comprising the step of streaming the user try-on video to a user device associated with the online shopper.

11. The method of claim 9, wherein the step of enabling the online shopper to select the product further comprises the step of providing a “try on” button on a user interface.

12. The method of claim 9, wherein the plurality of products are products that can be worn on the body or applied to the body of a consumer.

13. The method of claim 9, further comprising the step of allowing the online shopper to purchase the product.

14. The method of claim 9, further comprising the step of enabling the online shopper to share the user try-on video on a social network.

15. The method of claim 9, wherein the step of storing the user video profile includes the step of recording natural movements of the online shopper and saving the natural movements on a user video profile database.

16. The method of claim 9, wherein the step of storing the user video profile includes the step of obtaining a recording of natural movements of the online shopper from a user device associated with the online shopper and saving the natural movements on a user video profile database.

17. The method of claim 9, further comprising the step of analyzing the user video profile with respect to product video profiles of the plurality of products to determine one or more compatible products that have physical features compatible with physical features of the online shopper.

18. The method of claim 17, further comprising the step of combining the user video profile with each of the product video profiles of the one or more compatible products to create one or more recommended try-on videos.

19. The method of claim 18, further comprising the step of inquiring whether or not the online shopper wishes to virtually try-on the one or more recommended products.

20. The method of claim 19, wherein, if the online shopper wishes to virtually try-on the one or more recommended products, then streaming the one or more recommended try-on videos to a user device associated with the online shopper.
